(19) United States
(12) Patent Application Publication
(10) Pub. No.: US 2015/0342107 A1
(43) Pub. Date: Dec. 3, 2015

(54) Plough comprising a plurality of plough bodies attached to a plough bar

(71) Applicant: Hans Von Der Heide, Ibbenbueren-Laggenbeck (DE)

(72) Inventor: Hans Von Der Heide, Ibbenbueren-Laggenbeck (DE)

(21) Appl. No.: 14/722,787

(22) Filed: May 27, 2015

(30) Foreign Application Priority Data
May 28, 2014 (DE) 102014107515.3

(51) Int. Cl. A01B 15/02; A01B 3/40; A01B 59/06; A01B 73/02; A01B 49/02; A01B 63/10; A01B 63/00; A01B 15/18; A01B 59/00

(52) U.S. Cl. CPC A01B 15/02; A01B 15/18; A01B 3/40; A01B 59/066; A01B 59/00; A01B 49/027; A01B 63/10; A01B 63/008; A01B 73/02

(57) ABSTRACT

A plough comprising a plurality of plough bodies attached to a plough bar, wherein the plough bar is aligned at a right angle with respect to the working direction of the plough and wherein the plough bodies are arranged side-by-side on the plough bar for the purpose of ploughing a soil. In the disclosed plough, each plough body is a uniform component and has the shape of a tube that is bisected in longitudinal direction in a vertical plane and has slanted edges at its front and rear, wherein the longitudinal axes of the plough bodies are each aligned parallel to each other and at an angle with respect to the working direction of the plough.

### CROSS-REFERENCES TO RELATED APPLICATIONS

This application claims the benefit of the German patent application No. 10 2014 107 515.3 filed on May 28, 2014, the entire disclosures of which are incorporated herein by way of reference.

### BACKGROUND OF THE INVENTION

The present invention relates to a plough comprising a plurality of plough bodies attached to a plough bar, wherein the plough bar is aligned at a right angle with respect to the working direction of the plough and wherein the plough bodies are arranged side-by-side on the plough bar for the purpose of ploughing a soil.

Document DE 18 13 113 A discloses a known plough in which a plurality of plough bodies that are known as such and have a share and a moldboard is arranged spaced apart side-by-side on a central plough bar and at a right angle with respect to the working direction, said plough bodies receiving horizontal cutting edges and scraper plates on the side facing away from the moldboard, said cutting edges and scraper plates filling the working space between the shares of the neighboring plough bodies. When this plough according to the invention is used, the share takes up half the width of a strip of soil after a horizontal and vertical separation and passes it onto the moldboard in an accelerated manner. Therein, the vertical separation is supported both by disk coulters of known type and by cutting bars that are attached to the plough bodies in an exchangeable manner. It is also possible to use other separating devices, for example, driven milling cutters, in the stead of the disk coulters. At the same time, the cutting edge separates the remaining part of the strip of soil and passes it on to the scraper plate in an accelerated manner, said scraper plate conveying the strip of soil to the point behind the share and the moldboard at which the strip of soil has been separated and lifted by the share, while the part of the strip of soil disposed on the moldboard is deposited instead of that part of the strip of soil that has been lifted by the cutting edge. The conveyance/acceleration and the deposition of the strips of soil from the moldboard and the scraper plate are dependent on the angular position of the cutting edge, the distance between the cutting edge and the scraper plate and the angular position of the scraper plate with respect to the strip of soil. Due to this arrangement of the tools, the strip of soil is turned almost on the spot and the plough works without furrows.

In practice, however, when ploughs of the aforementioned type are in use, it has turned out that jams and congestions very easily occur between the plough bodies, with the result that the use of said ploughs is difficult or even impossible. Because of the plough body with the so-called runner and the attachment for the moldboard, the free passage between two neighboring plough bodies is limited in part and, in extreme cases, up to half of its width, inevitably resulting in jams and congestions. In like manner, the upright plough beam results in jams and congestions if the soil to be ploughed is covered with vegetation or loose residues. In addition, the usual moldboard height which approximately corresponds to the cutting width of the strip of soil often causes the strip of soil to be thrown onto the neighboring moldboard instead of being neatly deposited. Furthermore, the known plough has a multi-part structure and requires various adjustable elements, with the result that production and operation are complex.

DE 224 357 A shows a reversible plough with multiple shares. The plough has a plough beam which extends in longitudinal direction and to which an adjustable bar arrangement having the shape of a parallelogram is mounted. A plough share is mounted to each of two outer parallelogram bars that extend parallel to the plough beam. The plough shares are mounted on axles extending parallel to the plough beam and can be rotated by 180 degrees thereon and be locked in their end positions by means of detent mechanisms. This allows switching the plough from a first position of use in which it ploughs to the right, to a second position of use in which it ploughs to the left. Therein, the position of the plough and its plough shares shown in FIG. 4 of said document is only an intermediate position during the reversing process; this intermediate position, however, is not a position of use of the plough that is suitable and provided for ploughing. The central position of the adjustable parallelogram only serves to unlock the plough shares from their locked position, rotate them by 180 degrees and then lock them again. Thereafter, the parallelogram is, in any case, adjusted further until it reaches its end position. While ploughing is in progress, the plough shares are arranged in a slanted manner one after the other, as is the case with conventional ploughs.

Document DE 30 47 936 A1 shows a plough with which a strip of soil is cut and turned such that it is re-deposited in the same furrow, i.e., a lateral offset of the strip of soil is avoided. To achieve this, the plough is provided with a turning device which incorporates at least one conveying drum, preferably a plurality of conveying drums arranged in a row, said conveying drum(s) being allocated to a guide. Preferably, the/each conveying drum is rotating on an upward, i.e., essentially vertical axle, preferably with a forced drive. With this plough, only one single strip of soil is cut, turned and re-deposited in the same furrow; to achieve this, use is made of active driven elements. Due to its active driven elements in the form of the conveying drum or conveying drums, the plough is highly complex in terms of construction and highly prone to breakdown during operation.

DE 580 028 A shows a plough having a plough body for depositing the strip of soil to the side without turning it. To achieve this, the plough share has the shape of a cavity with bent-up sections on either side and a recess that is disposed therebetween, is open to the rear and extends to the front over a more or less long distance. When this plough is used for ploughing, the strip of soil is initially set up on its land side by means of the bent-up section present there, but then straightened again by means of the other furrow-side bent-up section that is somewhat recessed, with the result that a turning of the strip of soil is avoided. The recess is intended to provide for easy crumbling of the soil. The plough disclosed here is only a single-share plough which is provided with an advancing skim coulter.

### SUMMARY OF THE INVENTION

It is therefore an object of the present invention to create a plough of the aforementioned type, which obviates the drawbacks disclosed above and which, in particular, ensures trouble-free ploughing without the risk of jams and congestions and has a simple structure and compact design, in particular, with a short overall length.

This problem is solved by the invention by means of a plough of the aforementioned type, which is characterized in that each plough body is a uniform component and has the shape of a tube that is bisected in a longitudinal direction in a vertical plane and has slanted edges at its front and rear, wherein the longitudinal axes of the plough bodies are each aligned parallel to each other and at an angle with respect to the working direction of the plough.

Due to their special shape, the plough bodies do not require any plough beam to be attached to the plough bar. In fact, the plough bodies are to advantage in that they can be connected to the plough bar in their upper region. In addition, the plough according to the invention does not require the so-called runner on each plough body, which is provided in known ploughs. This allows achieving the advantage that is essential for the invention, namely, that no other components or elements of the plough required for holding, carrying and supporting the plough body or other parts of the plough and limiting the passage between neighboring plough bodies are arranged between said neighboring plough bodies. As a result, the space between two neighboring plough bodies is continuously free, this excluding any risk of jams or congestions during ploughing although the plough bodies are arranged side-by-side at a right angle to the working direction of the plough and do not include any offset relative to each other in working direction.

Appropriately, the forward slanted edge is rounded at its top and the rearward slanted edge is rounded at its top and bottom, in order to ensure that soil material and parts of plants can slide along the plough body and its edges without any trouble.

For reasons of stability and durability, the plough bodies are, preferably, made of steel. To reduce the friction of parts of the soil with and adhesion of such parts to the plough body, the latter can be provided with a plastic covering in regions of its surface which are swept over by the soil material, said plastic covering being appropriately attached such that it can be easily exchanged, e.g., by means of screws.

In a further embodiment, it is preferably provided for the plough that a part of the plough body that is at the latter's front, as seen in working direction, forms a plough share, wherein a lower free edge of the plough body that is at the latter's front as seen in working direction extends at an angle with respect to the working direction in a horizontal plane and is formed as a cutting edge. Advantageously, the plough share is integrated into the plough body and is held and supported by the remaining plough body, with the result that, for the plough share, no special components are required for holding and supporting said plough share.

Furthermore, the invention proposes that a central and rearward part of the plough body each form a moldboard, said parts being central and rearward as seen in working direction, and the upper longitudinal edge of said moldboard having a downward directional component at least over a part of its length. On the one hand, this also integrates the moldboard into the plough body. On the other hand, the downward directional component of the moldboard has the effect that vegetation or loose residues, if any are pushed from the surface of the soil to be ploughed across the forward slanted edge of the plough body onto the upper longitudinal edge thereof drop off the plough body and are well mixed with the turned and crumbling strip of soil.

In order to exclude any risk of jams or congestions between the plough bodies in a particularly reliable manner, it is preferably provided that any clear height measured from the cutting edge to an upper longitudinal edge of each plough body exceeds the lateral distance between two neighboring plough bodies of the plough. In this case, the strip of soil, when turned, can practically no longer be thrown onto the neighboring plough body and cause trouble there; instead, it can, at the most, bounce laterally against the neighboring plough body. In this manner, the soil material is intensely crumbled and mixed with organic matter that was applied beforehand or with vegetation and loose residues, said soil material then dropping into the furrow in a guided manner. This allows reaching a higher driving speed and an increased acreage capacity per time unit during ploughing. Advantageously, the clear cross-sectional area available for the passage of the strip of soil is in considerable excess of the cross-sectional area of the strip of soil itself, this contributing to a very high operational reliability and trouble-free operation of the plough.

Preferably, each plough body is attached to the plough bar in its upper region, either directly or by placing at least one distance piece in between. In the simplest case, the plough bodies are directly connected to the plough bar, preferably screwed to the plough bar for the purpose of easy exchangeability. If necessary, the distance piece or the distance pieces can be used to adjust for each plough body a distance from the plough bar provided this is advantageous for the function of the plough.

Since the plough bodies of the plough according to the invention have a relatively great height as compared with conventional ploughs, it may be appropriate for the absorption of forces acting on the plough bodies during use to support each plough body on its rearward convex side by means of at least one angular support element, wherein a vertical leg of the support element rests tangentially against the convex side of the plough body and wherein a horizontal leg of the support element faces the forward concave side of the plough body and is connected to the plough bar and/or to the plough body. The support element supports the respectively allocated plough body laterally without narrowing the free passage between neighboring plough bodies. If it is designed as an elongated angle plate, the support element is, in addition, to advantage in that it forms a baffle for soil material which the neighboring plough body turns in the direction towards the support element. This facilitates a markedly increased ploughing speed without there being the risk that the ploughed soil material is thrown far off laterally in an unintentional manner; this is to advantage in that it results in an increased acreage capacity per time unit during ploughing.

Due to the special design and shape of the plough bodies of the plough according to the invention described above, each plough body can, advantageously, be designed integrally, this facilitating a particularly easy manufacture and assembly of the plough according to the invention.

As an alternative, each plough body can be formed from a plurality of single parts that are connected to each other in a detachable or an undetachable manner. In this embodiment, it is in particular possible to take account of the fact that, during operation, different regions and parts of the plough body are subject to stresses of varying degrees and to wear and tear of varying degrees. It is therefore appropriate that the single parts of each plough body should be designed according to their stress, particularly with regard to the material used and/or the material thickness used. More preferably, the particularly stressed plough share including the cutting edge can be an exchangeable single part which, appropriately, is made from a harder and more wear resistant material than the remaining part of the plough body. Detachable screwed connections are preferred for connecting the plough body parts to each other.

Since the longitudinal direction of the plough bodies extends at an angle with respect to the working direction of the plough, the force resulting while the plough is used deviates laterally from the working direction. In order to absorb this force that deviates from the working direction and to prevent the plough from deviating from the desired working direction, the invention proposes that the plough should comprise on its longitudinal side which is faced by the forward ends of the plough bodies a runner element that is disposed in a vertical plane, extends in working direction, is attached to the plough bar or to a plough frame and can be supported against a vertical furrow edge of the soil in a sliding manner during operation.

In order to relieve a towing vehicle that draws the plough, more particularly an agricultural tractor, of the weight of the plough at least in part, it is proposed that a running wheel which rolls off on a still unploughed soil surface during operation should be arranged on the plough bar or the plough frame on the longitudinal side of the plough that comprises the runner element, laterally and externally with respect to the runner element.

Likewise for the aforementioned reason, a supporting wheel which rolls off in a lower corner region between a lower-level furrow bottom and a higher-level still unploughed soil surface during operation can be arranged on the plough bar or the plough frame on the longitudinal side of the plough opposite to the runner element, in front of the outermost plough body arranged there as seen in working direction. In addition to the weight relieving function, this supporting wheel also features a guide for the plough in the working direction thereof and supports the function of the runner element.

In order that the supporting wheel can fulfil the desired guide function as perfectly as possible, the supporting wheel preferably comprises a rotational axis that is disposed at an angle in a vertical plane and, as seen in cross-section, a running tread of the supporting wheel preferably comprises a contour that is, in essence, rectangular and is adjusted to the corner region between the furrow bottom and the higher-level still unploughed soil surface.

For the purpose of adjustment to different fields of application, more particularly for the adjustment of a desired ploughing depth, the invention proposes that the running wheel and/or the supporting wheel can be adjusted in height relative to the remaining plough. To achieve this, an adjusting spindle can, for example, be allocated to each of the wheels.

Furthermore, it is preferably provided that the running wheel and the supporting wheel are mounted to a common lever arm arrangement and can be adjusted in height together with the same relative to the remaining plough, said lever arm arrangement facing to the rear and being pivotable in vertical direction. This lever arm arrangement can, for example, be adjusted by means of a spindle or a hydraulic piston-cylinder unit. Therein, the pivot axis of the lever arm arrangement appropriately extends at a right angle with respect to the longitudinal direction of the plough.

In order to pre-cut the soil to be ploughed and any material, more particularly plants or parts of plants, that might be present thereon and/or therein in vertical direction, a coulter is appropriately arranged in front of each plough body (as seen in working direction) in alignment with the foremost tip of said plough body.

Therein, the coulters preferably are disk coulters with a smooth or toothed or serrated circumference that are freely rotating on a common rotational axis which extends parallel to the plough beam. In the plough according to the invention, the disk coulters can be designed with a large diameter without any difficulties because the coulters can be arranged in a region of the plough where they do not collide with other parts of the plough. Preferably, the disk coulters have a diameter that is more than twice as large as the maximum ploughing depth of the plough, in order to cut vertically into the soil down to the provided ploughing depth.

In order to quickly and easily put all coulters to a desired uniform height or depth position relative to the remaining plough, it is provided that the coulters are mounted to a common lever arm arrangement and can be adjusted in height together with the same relative to the remaining plough, said lever arm arrangement facing to the rear and being pivotable in vertical direction. The lever arm arrangement for the coulters, too, can, for example, be adjusted by means of a spindle or a hydraulic piston-cylinder unit. Therein, the pivot axis of this lever arm arrangement also appropriately extends at a right angle with respect to the longitudinal direction of the plough.

In a further embodiment of the plough, it is proposed that a baffle wall that is, in essence, vertical and is intended for soil material turned by the outermost outwardly turning plough body is arranged externally from and next to the outermost outwardly turning plough body. Therein, the baffle wall is, preferably, attached to the plough such that it can be moved in height and/or in pendulum fashion in order that it can overcome obstacles on the soil without being damaged. The baffle wall can extend parallel to the longitudinal direction of the plough bodies or in the working direction of the plough or in a direction extending therebetween.

In order to couple the plough to and uncouple it from a towing vehicle quickly and easily, the plough appropriately comprises at its front side standardized coupling elements for detachably attaching the plough to a standardized coupling of a tractor, such as a three-point coupling.

Since the plough according to the invention has an overall length that is short because the plough bodies are arranged side-by-side, it is appropriate to combine the plough with further working devices to carry out different work operations on a field in one go. In this respect, the invention proposes that the plough should comprise connecting element to attach one or a plurality of further working devices in a detachable manner. Preferably, the connecting elements are provided in a rear region of the plough, appropriately at the rear end of the plough frame, in order to attach and/or hitch one or a plurality of further working devices or assemblies there. This can, for example, be a packer unit for compacting the ploughed soil or a clod breaker or a rotary power take-off cross harrow or a semi-integral drilling machine.

If a packer unit, preferably having steel disks, is attached to the plough to recompact the ploughed soil, the runner element that has been described above can be done without on the plough because, in this case, the packer unit suffices to ensure that the plough is appropriately guided in a straight ahead manner.

A further embodiment of the plough proposes that the coupling elements and/or the connecting elements can be adjusted in the longitudinal direction of the plough and fixed in place in desired positions. In this manner, the position of the plough relative to a tractor drawing the same and/or the position of a further working device attached to the plough relative to the plough can be varied and in each case be adjusted in an optimal manner. Therein, it is even possible as required to arrange a flat working device, such as a crop chopper, underneath a forward region of the plough in front of the plough bodies thereof, said crop chopper, for example, additionally chopping plant stubbles still present on the surface to be ploughed immediately prior to ploughing.

In order to be able to connect working devices having driven components to the plough using the connecting elements thereof, it is proposed that a power take-off shaft that extends in the longitudinal direction of the plough should be arranged on the plough, wherein said power take-off shaft can be connected to a power take-off shaft connection of a tractor towing the plough on its forward side and, on its rearward side, to a working device that is connected to the plough via the connecting elements thereof. Therein, the power take-off shaft appropriately extends along a longitudinal central line of the plough and is mounted such that it is pivoting in two bearings that are spaced apart from each other in longitudinal direction. To be adjusted to different working devices, the power take-off shaft of the plough can be designed variable in length.

The connecting elements that are provided on the plough according to the invention and the power take-off shaft that is likewise provided as the case may be allow forming a variety of versatile device combinations as required, in order to carry out various soil working steps in addition to ploughing in one go, which had so far to be carried out one after the other in a plurality of working steps and, therefore, with a far higher expenditure of time.

If the plough according to the invention is so wide that it can no longer be driven on public roads, it is appropriately provided that lateral outer parts of the plough and working devices that are possibly connected to the plough are designed such that they can be folded-in in in an upward direction or in an upward and inward direction. In this manner, the plough can be reduced in its width such that it is allowed to be driven on public roads. To achieve this, hinges facilitating the desired folding motion are preferably installed in the cross beams of the plough. In this case, the end positions of the folding motion of the cross beams can appropriately be defined by locking means and secured such that they cannot be readjusted in an undesired and self-acting manner.

Depending on their composition and humidity, farmland soils can have sticky properties. In order to avoid disturbances in the ploughing operation by parts of the soil sticking to the plough bodies on the rear in such soils as well, it is provided that the plough bodies each feature a non-stick coating on their rearward convex side. This non-stick coating can, for example, be a plastic coating which has to have a small thickness only because, here, the mechanical stress during ploughing is relatively low.

In order to facilitate ploughing in a particularly effective manner without the plough having to be designed as a reversible plough with double plough bodies and a complex reversing mechanism for reversing the plough, the invention proposes that the plough should, in a first embodiment, be designed as a plough that ploughs to the right and, in a second embodiment, as a plough that ploughs to the left and that a right-ploughing plough and a left-ploughing plough can be attached to a tractor both on the forward and rearward sides thereof and be alternately used in forward and reverse gear of the tractor, wherein the towed plough always is the ploughing plough. As a result, the tractor just has to drive to and fro in parallel runs for ploughing, without having to turn at the edge of the field. Therein, it is particularly advantageous if the tractor features what is called a crab steering mechanism which makes moving the tractor from one run to the next run particularly easy. This embodiment of the invention considerably reduces or even makes totally superfluous what is called the headland, i.e., the area required for turning the set consisting of tractor and plough, thus avoiding losses in yield by soil compaction in the headland. Furthermore, this is to advantage in that the respective plough that is not in operation substitutes an additional or counter weight on the tractor that has so far been usual during ploughing with only one plough. This saves moving useless masses and reduces the fuel consumption and the wear of the tractor. Herein, it is also advantageous that the tractor does not drive in the ploughed furrow but moves across unploughed areas with all of its wheels, thus advantageously avoiding a compaction of the plough pan. Since, for this type of application, the plough according to the invention is designed with only one set of plough bodies and without reversing mechanism, it can be manufactured in a particularly cost-effective manner, with the result that two such ploughs, i.e., a right-ploughing plough and a left-ploughing plough, are not more expensive in total than a conventional reversible plough with the same performance.

As an alternative to the embodiment described in the paragraph above, the plough according to the invention can also be designed as a reversible plough wherein, in this case, it comprises two sets of plough bodies, i.e., a right-ploughing one and a left-ploughing one, as well as a reversing mechanism for reversing the plough by a total of 180 degrees or a plurality of reversing mechanisms for reversing one pair of plough bodies each by 180 degrees.

### BRIEF DESCRIPTION OF THE DRAWINGS

Below, an exemplary embodiment of the plough according to the invention will be illustrated by means of a drawing. In the drawing,

FIG. 1 is a top view of a plough;

FIG. 2 is a lateral view of a plough body of the plough shown in FIG. 1;

FIG. 3 is a cross-sectional view of a plough body in a first embodiment;

FIG. 4 is a cross-sectional view of the plough body in a second embodiment;

FIG. 5 is a cross-sectional view of the plough body in a third embodiment;

FIG. 6 is a cross-sectional view of the plough body together with a support element; and

FIG. 7 is a cross-sectional view of a soil surface worked by the plough together with a supporting wheel as a part of the plough.

### DETAILED DESCRIPTION OF THE PREFERRED EMBODIMENTS

In the following description of the figures, identical parts in the different figures will always be referred to with the same reference numbers, with the result that it is not necessary to illustrate all reference numbers for each figure of the drawing.

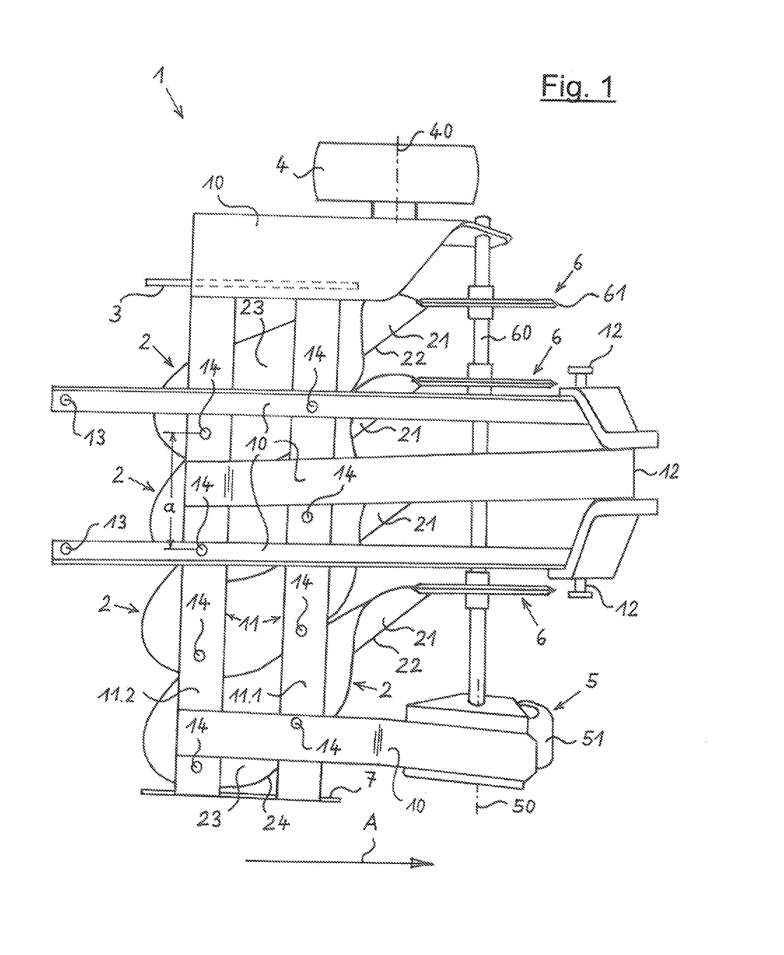

FIG. 1 of the drawing is a top view of a plough 1 wherein the front side of the plough 1 points to the right and, therefore, the working direction A of the plough 1 extends from left to right in the plane of the drawing.

The plough 1 has a plough frame 10 which, in the illustrated instance, comprises two horizontal longitudinal beams extending parallel to each other in working direction A, one diagonal beam which is arranged therebetween and extends from back to front in an inclined upward direction, and two front-end head pieces which are each connected, more preferably welded, to one of the longitudinal beams at their bottom and to the diagonal beam at their top. The head pieces carry standardized coupling elements 12, in the illustrated instance for a three-point coupling of a towing vehicle, such as an agricultural tractor.

Connected to the plough frame 10 is a plough bar 11 that extends at a right angle to the working direction A and, in the illustrated instance, is formed from two bar parts 11.1 and 11.2 that extend parallel to each other and are offset with respect to each other in working direction A. In the illustrated instance, a total of four plough bodies 2, which are arranged side-by-side without any offset in the longitudinal direction or working direction A of the plough 1, are connected to the plough bar 11 or, rather, its parts 11.1, 11.2. The plough bodies 2 are spaced apart from each other by a horizontal distance a as seen transverse with respect to the working direction A.

Each plough body 2 is a uniform component and, in essence, has the shape of a tube that is bisected in longitudinal direction in a vertical or approximately vertical plane and has slanted edges at its front and rear. Therein, the longitudinal axes of the plough bodies 2 are aligned parallel to each other and at an angle to the working direction A of the plough, in the instance illustrated in FIG. 1 such that the plough 1 is ploughing to the right.

In the illustrated instance, the plough bodies 2 are directly attached to the plough bar 11 and, therefore, do not need any plough beam to be attached to the plough bar 11. In addition, the plough 1 does not have what is called the runner on each plough body 2, which is provided in known ploughs. This has the effect that no other components or elements of the plough 1 required for holding, carrying and supporting the plough body 2 or other parts of the plough and limiting the passage between neighboring plough bodies 2 are arranged between said neighboring plough bodies 2. As a result, the space between two neighboring plough bodies 2 is continuously free, this excluding any risk of jams or congestions during ploughing although the plough bodies 2 are arranged side-by-side at a right angle to the working direction A of the plough 1 and do not include any offset in relation to each other in working direction A.

For reasons of stability and durability, the plough bodies 2 and, appropriately, the other mechanically stressed parts of the plough 1 as well are, preferably, made of steel. To reduce the friction of parts of the soil with and adhesion of such parts to the plough body 2, the latter can be provided with a plastic covering (not shown) in regions of its surface which are swept over by the soil material, said plastic covering being appropriately attached such that it can be easily replaced, e.g., by means of screws. As an alternative or in addition, a non-stick coating made of plastic can be provided on the rear of the plough bodies 2 in order to prevent sticky parts of the soil from adhering there in a disturbing manner.

On their top side, the plough bodies 2 are each connected, appropriately screwed, to the plough bar by means of two attachment sites 14. When required, it is also possible to provide more than two attachment sites 14 in each case.

A part of each plough body 2 that is at the front thereof, as seen in working direction, forms a plough share 21, wherein a lower free edge of the plough body 2 extends at an angle to the working direction A in a horizontal plane and is formed as a cutting edge 22, said lower free edge being at the front of said plough body 2 as seen in working direction A. In the illustrated instance, the plough share 21 is integrated into the plough body 2 and is held and supported by the remaining plough body 2, with the result that, for the plough share 21, no special components are required for holding and supporting said plough share 21.

A central and rearward part of the plough body 2 each form a moldboard 23, said parts being central and rearward as seen in working direction A, wherein the upper longitudinal edge 24 of said moldboard 23 has a downward directional component at least over a part of its length. The moldboard is, therefore, also integrated into the plough body 2. The downward directional component of the upper longitudinal edge 24 of the moldboard 23 has the effect that vegetation or loose residues, if any, are pushed from the surface of the soil to be ploughed across the forward slanted edge of the plough body 2 onto the upper longitudinal edge 24 thereof can drop off the plough body 2 by gravity in a self-acting manner and be well mixed with the turned and crumbling strip of soil.

Since the longitudinal direction of the plough bodies 2 extends at an angle with respect to the working direction A of the plough 1, the force resulting while the plough 1 is in use deviates laterally from the working direction A. In order to absorb this force deviating from the working direction A, and to prevent the plough 1 from deviating from the desired working direction A, the plough 1 comprises on its longitudinal side which is faced by the forward ends of the plough bodies 2—in the illustrated instance on the left side as seen in working direction A—a runner element 3 which is disposed in a vertical plane, extends in the working direction A, is attached to the plough bar 11, and can be supported against a vertical furrow edge of the soil in a sliding manner during operation.

On the longitudinal side of the plough 1, which comprises the runner element 3, a running wheel 4 is arranged on the plough frame 10 laterally and externally with respect to the runner element 3. While the plough 1 is in use, the running wheel 4 rolls off a still unploughed soil surface and relieves the towing vehicle that draws the plough 1 of the weight of the plough 1, at least in part.

Furthermore, a supporting wheel 5, which rolls off in a lower corner region between a lower-level furrow bottom and a higher-level still unploughed soil surface during operation, is arranged on the plough frame 10 on the longitudinal side of the plough 1 opposite to the runner element 3, in front of the outermost plough body 2 arranged there as seen in working direction A. In addition to the weight relieving function, this supporting wheel 5 also features a guide for the plough 1 in the working direction A thereof and supports the function of the runner element 3.

In the exemplary embodiment shown in FIG. 1, the running wheel 4 and the supporting wheel 5 are attached to the remaining plough 1 at a fixed level. As an alternative, the running wheel 4 and the supporting wheel 5 can be mounted to a common lever arm arrangement and can be adjusted in height together with the same relative to the remaining plough 1, said lever arm arrangement facing to the rear and being pivotable in vertical direction. For example, the lever arm arrangement can be designed in the form of a cross beam comprising parallel arms for the running wheel 4 and the supporting wheel 5, said arms being permanently attached to said cross beam and facing to the rear as seen in the longitudinal direction of the plough 1, wherein the cross beam is mounted to the remaining plough 1 by means of an adjusting device, such as a spindle or a piston-cylinder unit, such that it is pivotable on its longitudinal axis, so as to be able to adjust the level of the running wheel 4 and the supporting wheel 5 relative to the remaining plough 1 and therefore the engaging or ploughing depth of the plough bodies 2 in the soil to be ploughed.

A coulter 6 is arranged in front of each plough body 2, as seen in working direction A, in alignment with the foremost tip of said plough body 2. The coulters 6 serve to pre-cut the soil to be ploughed and any material, more particularly plants or parts of plants, that might be present thereon and/or therein in vertical direction. In the illustrated instance, the coulters 6 are designed as disk coulters with a smooth edge-like circumference that are freely rotating on a common rotational axis 60 extending parallel to and in front of the plough bar 11. As an alternative, the disk coulters can also be designed with a toothed or serrated circumference. In the illustrated instance, only three of the four coulters 6 allocated to the four plough bodies 2 are visible because one coulter 6 is covered by the diagonal beam of the plough frame 10 extending across said coulter 6.

As an alternative to the exemplary embodiment shown, the coulters 6 can be mounted to a common lever arm arrangement and can be adjusted in height together with the same relative to the remaining plough 1, said lever arm arrangement facing to the rear and being pivotable in vertical direction. For example, the lever arm arrangement can be designed in the form of a cross beam that is designed as a tube, such as a square tube, and comprises parallel arms for each coulter 6, said arms being permanently attached to said cross beam and facing to the rear as seen in the longitudinal direction of the plough 1, wherein the cross beam is mounted to the remaining plough 1 by means of an adjusting device, such as a spindle or a piston-cylinder unit, such that it is pivotable on its longitudinal axis, so as to be able to adjust the engaging or cutting depth of the coulters 6 in the soil to be ploughed.

In the plough 1 according to the invention, the coulters 6 can be designed as disks having a large diameter without any difficulties because the coulters 6 can be arranged in a region of the plough 1 where they do not collide with other parts of the plough. Preferably, the disk coulters have a diameter that is more than twice as large as the maximum ploughing depth of the plough 1, in order to cut vertically into the soil down to the provided ploughing depth. The plough bodies 2 will then only have to still make the horizontal cut on the bottom side of the strip of soil to be turned with their plough share 21, this relieving the plough bodies 2 of mechanical stress.

An essentially vertical baffle wall 7 for soil material turned by the outermost plough body 2 turning in outward direction is arranged laterally and externally next to said outermost plough body 2 turning in outward direction, i.e., on the right side of the plough 1 as seen in the working direction A. Therein, the baffle wall 7 can be rigidly connected to the plough beam 11. As an alternative, the baffle wall 7 is attached to the plough 1 such that it can be moved in height and/or in pendulum fashion in order that it can overcome obstacles on the soil without being damaged. The longitudinal direction of the baffle wall 7 can extend parallel to the longitudinal direction of the plough bodies or in the working direction A of the plough 1 or in a direction extending therebetween.

At its rear end which is the left one in FIG. 1 and, specifically in the illustrated instance, at the rear ends of the longitudinal beams 10, the plough 1 comprises connecting elements 13 for attaching one or a plurality of further working devices in a detachable manner. Appropriately, the connecting elements 13 are standardized elements in order to be able to attach customary working devices to the plough 1. The coupling elements 12 and/or the connecting elements 13 can be arranged on the plough 1 in a defined position or, alternatively, be adjustable in the longitudinal direction of the plough 1 and fixable in place in desired positions.

A power take-off shaft that is now shown in the illustrated instance and extends in the longitudinal direction of the plough 1 and is disposed below the diagonally extending central beam 10 can be arranged on the plough 1, wherein said power take-off shaft can be connected to a power take-off shaft connection of a tractor towing the plough 1 on its forward side and, on its rearward side, to a working device that is connected to the plough 1 via the connecting elements 13 thereof. In its rear end region, the diagonally extending central beam 10 can incorporate an opening or bifurcation for passing the power take-off shaft therethrough. For example, the power take-off shaft of the plough 1 can then be used to drive a rotary drive of a disk harrow or a drilling machine which is attached to the plough.

In the illustrated instance, the plough 1 has four plough bodies 2 and, therefore, a relatively small width. If the plough 1 comprises a higher number of plough bodies 2 and, therefore, has a greater width, hinges which allow folding in lateral outer parts of the plough 1 in an upward or in an upward and inward direction can be arranged on the plough 1, for example, in the cross beams 11.1 and 11.2, in order to reduce the width of the plough 1 for the transport thereof and to allow driving it on public roads.

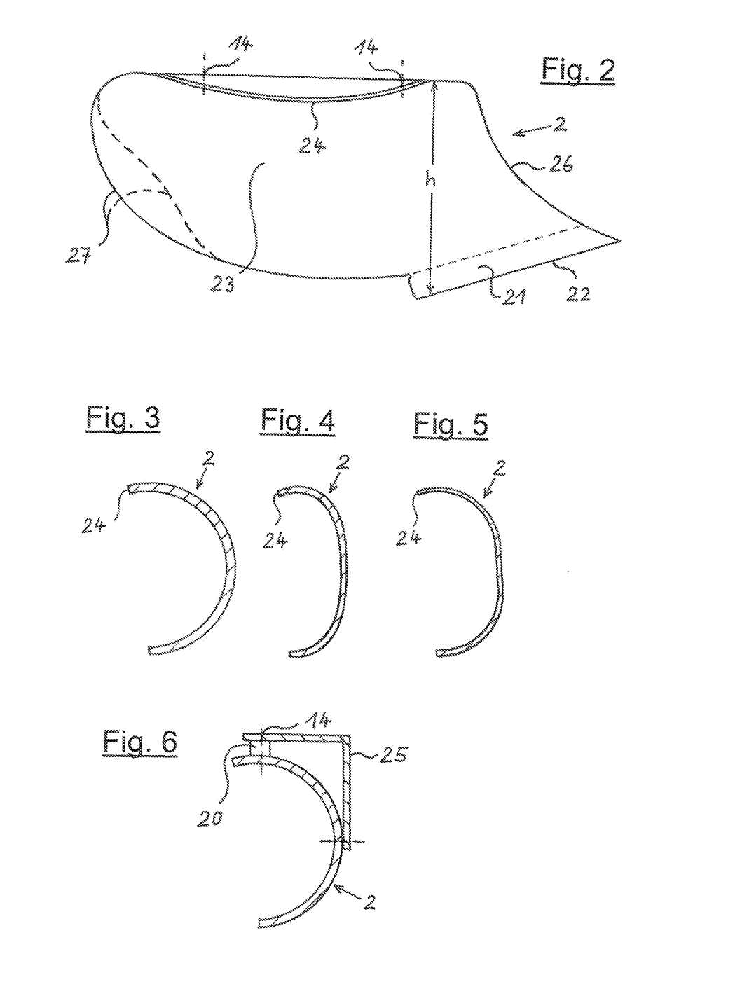

FIG. 2 of the drawing is a lateral view of a plough body 2 of the plough 1 shown in FIG. 1 as a single part, showing the convex side of the plough body 2 that points to the right as seen in the working direction A of FIG. 1.

The plough body 2 is a uniform component and, in essence, has the shape of a tube that is bisected in a longitudinal direction in a vertical plane and has slanted edges 26 and 27 at its front and rear. The plane along which the imaginary tube is bisected is, in essence, disposed in the vertical or is slightly inclined with respect to the vertical. As seen from the front backwards, the forward edge 26 of the plough body 2 is formed such that it ascends upwards at an angle; as seen from the front backwards, the rearward edge 27 extends from the bottom upwards at an angle. The run of the edge of the plough body 2 is rounded off between the forward edge 26 and the upper longitudinal edge 24 of the plough body 2 so as to avoid disturbing corners. For the same reason, the transitions from the rearward edge 27 of the plough body 2 to the upper longitudinal edge 24 thereof and to the lower longitudinal edge thereof are also rounded off. Since the forward slanted edge 26 is rounded at its top and the rearward slanted edge 27 is rounded at its top and bottom, it is ensured that soil material and parts of plants can slide along the plough body 2 and its edges 24, 26 and 27 without any trouble.

As is indicated by a dashed line at the rear end of the plough body 2, said rear end being disposed on the left in FIG. 2, the rear edge 27 of the plough body 2 can also comprise a contour differing from the continuous contour, so as to adjust the plough body 2 to varying soil properties and optimize its mode of functioning accordingly.

A forward part of the plough body 2 that is the right lower part thereof as seen in FIG. 2 forms a plough share 21, wherein a lower forward free edge of the plough share 21 extends in a horizontal plane at an angle with respect to the working direction A shown in FIG. 1 and is formed as a cutting edge 22. The plough share 21 can be formed integrally with the remaining plough body 2. As an alternative, the plough share 21 with the heavily loaded cutting edge 22 can also be a separate single part that is made of a particularly wear-resistant material and is connected, more appropriately screwed, to the remaining plough body 2 in a detachable manner.

A central and rearward part of the plough body 2 each form a moldboard 23, said parts being central and rearward as seen in the longitudinal direction of the plough body 2, wherein the upper longitudinal edge 24 of said moldboard 23 has a downward directional component at least over a part of its length, in order to cause any materials that might have been pushed up during ploughing to drop off in a self-acting manner.

In the plough 1 shown in FIG. 1, the plough bodies 2 are spaced apart from each other by a horizontal distance a as seen transverse with respect to the working direction A. As shown in FIG. 2, the plough body 2 has a clear height h measured from the cutting edge 22 to its upper longitudinal edge 24. This clear height h exceeds the lateral distance a between two neighboring plough bodies 2 of the plough 1, thus ensuring free passage and trouble-free turning of the strip of soil during ploughing.

As indicated in FIG. 1 and FIG. 2, the plough body 2 can, in its upper region, be attached directly to the plough bar 11 by means of the connecting sites 14.

For stiffening purposes, each plough body 2 can be provided with pressed-in seams or with flat reinforcing fins on its rear.

As seen in cross-section, the plough body 2 can have different forms, three of which are shown by way of example in FIGS. 3, 4 and 5.

In FIG. 3, the plough body 2 essentially has the form of a semicircle as seen in cross-section. In FIG. 4, the plough body 2 essentially has the form of a half-ellipse as seen in cross-section, and in FIG. 5, it has the form of a half-oval, wherein the long diameter line extends in an approximately vertical direction in each of the two embodiments last mentioned.

In each of the three examples shown here, a line connecting the upper and lower longitudinal edges of the plough body 2 is slanted at an angle of approximately 5 to 10 degrees with respect to the vertical, in order to give the upper longitudinal edge 24 a directional component that is facing down.

FIG. 6 shows an example of a plough body 2 in which said plough body 2 is supported by an angular support element 25 on its convex side. A lower vertical leg of the support element 25 rests tangentially against the convex side of the plough body wherein, in the illustrated instance, there may also be a mechanical connection, such as a screwed connection. An upper horizontal leg of the support element 25 extends across the plough body 2 and faces the concave side of the plough body 2 and is connected to the plough body 2 with a distance piece 20 being placed in between. The arrangement comprising the plough body 2, support element 25 and distance piece 20 can be pre-assembled as a unit and then be attached to the plough bar 11.

The support element 25 supports the allocated plough body 2 laterally without narrowing the free passage between neighboring plough bodies 2. If it is designed as an elongated angle plate, the support element 25 is, in addition, to advantage in that it forms a baffle for soil material that the neighboring plough body 2 turns in the direction towards the support element 25.

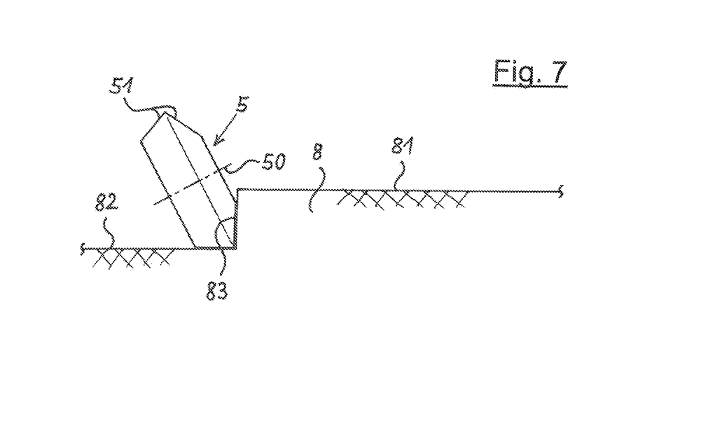

Finally, FIG. 7 is a schematic cross-sectional view of a soil 8 to be ploughed by the plough 1 according to FIG. 1, in a viewing direction opposite to the working direction A according to FIG. 1. On the right in FIG. 7, there is a soil surface 81 that has not been ploughed yet; on the left in FIG. 7, a ploughed furrow can be seen with a furrow bottom 82 that is disposed at a level that is lower than the unploughed soil surface by the ploughing depth 81. The transition from the unploughed soil surface 81 to the furrow bottom 82 forms a vertical furrow edge 83.

As illustrated in FIG. 7, the corner region between the furrow bottom 82 and the furrow edge 83 can be used to guide the aforementioned supporting wheel 5, so as to support the guidance of the plough 1 in its desired working direction A. To be adjusted to the corner region between the furrow bottom 82 and the furrow edge 83 and to introduce forces into the soil 8 in a favorable manner, the supporting wheel 5 can have an inclined rotational axis 50 and a rectangular contour of its running tread 51, as is shown in FIG. 7 by way of example.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE NUMBERS

| Number | Designation |
|---|---|
| 1 | Plough |
| 10 | Plough frame |
| 11 | Plough bar |
| 11.1, 11.2 | Parts of 11 |
| 12 | Coupling elements |
| 13 | Connecting elements |
| 14 | Attachment sites of 2 to 11 |
| 2 | Plough body |
| 20 | Distance piece |
| 21 | Plough share |
| 22 | Cutting edge |
| 23 | Moldboard |
| 24 | Upper longitudinal edge |
| 25 | Support element |
| 26 | Forward slanted edge of 2 |
| 27 | Rearward slanted edge of 2 |
| 3 | Runner element |
| 4 | Running wheel |
| 40 | Rotational axis |
| 5 | Supporting wheel |
| 50 | Rotational axis |
| 51 | Running tread of 5 |
| 6 | Coulters |
| 60 | Rotational axis |
| 61 | Circumference |
| 7 | Baffle wall |
| 8 | Soil |
| 81 | Unploughed soil surface |
| 82 | Furrow bottom |
| 83 | Furrow edge |
| A | Working direction |
| a | Plough body spacing |
| h | Plough body height |

1. A plough comprising:
a plurality of plough bodies attached to a plough bar,
the plough bar being aligned at a right angle with respect to a working direction of the plough,
the plough bodies being arranged side-by-side on the plough bar for the purpose of ploughing a soil,
each plough body being a uniform component and having a shape of a tube that is bisected in a longitudinal direction in a vertical plane and having slanted edges at its front and rear,
longitudinal axes of the plough bodies each being aligned parallel to each other and at an angle with respect to the working direction of the plough.

2. The plough according to claim 1, wherein a part of the plough body at a front of the plough, as seen in the working direction, forms a plough share, wherein a lower free edge of the plough body at the front of the plough, as seen in the working direction, extends at an angle with respect to the working direction in a horizontal plane and is formed as a cutting edge.

3. The plough according to claim 1, wherein a central and rearward part of the plough body each form a moldboard, said parts being central and rearward, as seen in the working direction, and an upper longitudinal edge of said moldboard having a downward directional component at least over a part of its length.

4. The plough according to claim 2, wherein any clear height measured from the cutting edge to an upper longitudinal edge of each plough body exceeds a lateral distance between two neighboring plough bodies of the plough.

5. The plough according to claim 1, wherein each plough body is attached to the plough bar in its upper region, either directly or by placing at least one spacer in between.

6. The plough according to claim 5, wherein each plough body is supported on its rearward convex side by means of at least one angular support element, wherein a vertical leg of the support element rests tangentially against the convex side of the plough body and wherein a horizontal leg of the support element faces a forward concave side of the plough body and is connected to at least one of the plough bar and the plough body.

7. The plough according to claim 1, wherein each plough body is formed from a single part.

8. The plough according to claim 1, wherein each plough body is formed from a plurality of single parts that are connected to each other in a detachable or in an undetachable manner.

9. The plough according to claim 1, wherein the plough comprises on its longitudinal side, which is faced by the forward ends of the plough bodies, a runner element, that is disposed in a vertical plane extending in the working direction, and is attached to the plough bar or to a plough frame and is configured to be supported against a vertical furrow edge of the soil in a sliding manner during operation.

10. The plough according to claim 9, wherein a running wheel which is arranged to roll off on a still unploughed soil surface during operation is arranged on the plough bar or the plough frame on the longitudinal side of the plough that comprises the runner element, laterally and externally with respect to the runner element.

11. The plough according to claim 9, wherein a supporting wheel which is arranged to roll off in a lower corner region between a lower-level furrow bottom and a higher-level still unploughed soil surface during operation is arranged on the plough bar or the plough frame on a longitudinal side of the plough opposite to the runner element, in front of the outermost plough body arranged there, as seen in the working direction.

12. The plough according to claim 11, wherein the supporting wheel comprises a rotational axis disposed at an angle in a vertical plane and, as seen in cross-section, a running tread of the supporting wheel comprises a contour that is substantially rectangular and is adjusted to the corner region.

13. The plough according to claim 10, wherein at least one of the running wheel and the supporting wheel are adjustable in height relative to the remaining plough.

14. The plough according to claim 13, wherein the running wheel and the supporting wheel are mounted to a common lever arm arrangement and are adjustable in height together with the lever arm arrangement relative to the remaining plough, said lever arm arrangement facing to the rear and being pivotable in a vertical direction.

15. The plough according to claim 1, wherein a coulter is arranged in front of each plough body as seen in the working direction in alignment with the foremost tip of said plough body.

16. The plough according to claim 15, wherein the coulters are disk coulters with one of a smooth, toothed and serrated circumference that are freely rotating on a common rotational axis which extends parallel to the plough beam.

17. The plough according to claim 15, wherein the coulters are mounted to a common lever arm arrangement and can be adjusted in height together with the lever arm arrangement relative to the remaining plough, said lever arm arrangement facing to the rear and being pivotable in a vertical direction.

18. The plough according to claim 1, wherein a baffle wall that is substantially vertical and is configured to engage soil material turned by an outermost outwardly turning plough body is arranged externally from and next to the outermost outwardly turning plough body.

19. The plough according to claim 1, wherein the plough comprises at its front side standardized coupling elements configured to detachably attach the plough to a standardized coupling of a tractor.

20. The plough according to claim 1, wherein the plough comprises connecting elements to attach one or more working devices in a detachable manner.

21. The plough according to claim 19, wherein at least one of the coupling elements and the connecting elements are adjustable in the longitudinal direction of the plough and fixable in place in desired positions.

22. The plough according to claim 20, wherein a power take-off shaft extending in the longitudinal direction of the plough is arranged on the plough, wherein said power take-off shaft is configured to be connected to a power take-off shaft connection of a tractor towing the plough on its forward side and, on its rearward side, to a working device that is connected to the plough via the connecting elements thereof.

23. The plough according to claim 1, wherein lateral outer parts of the plough and working devices that may be connected to the plough are configured such that they can be folded-in in an upward direction or in an upward and inward direction.

24. The plough according to claim 1, wherein the plough bodies each include a non-stick coating on their rearward convex side.

25. The plough according to claim 1, wherein the plough is, in a first embodiment, designed as a plough that ploughs to the right and, in a second embodiment, as a plough that ploughs to the left, and that a right-ploughing plough and a left-ploughing plough are attachable to a tractor both on the forward and rearward sides thereof and may be alternately used in a forward and a reverse gear of the tractor, wherein the towed plough always is the ploughing plough.
